(19) United States
(12) Patent Application Publication
(10) Pub. No.: US 2018/0198150 A1
(43) Pub. Date: Jul. 12, 2018

(54) SINGLE-PHASE PEROVSKITE-BASED SOLID ELECTROLYTE, SOLID OXIDE FUEL CELL COMPRISING SAME, AND METHOD FOR MANUFACTURING SAME

(71) Applicant: KOREA INSTITUTE OF INDUSTRIAL TECHNOLOGY, Cheonan-si (KR)

(72) Inventors: Ho Sung Kim, Gwangju (KR); Kyeong Joon Kim, Gwangju (KR); Seung Woo CHOI, Gwangju (KR); Min Young KIM, Gwangju (KR); Yu Sin KIM, Gwangju (KR)

(21) Appl. No.: 15/506,419

(22) PCT Filed: Jun. 16, 2015
(86) PCT No.: PCT/KR2015/006076

§ 371 Date: Feb. 24, 2017

(30) Foreign Application Priority Data
Aug. 28, 2014 (KR) 10-2014-0112998

(51) Int. Cl. H01M 8/1246; C01G 15/00

(52) U.S. Cl. CPC H01M 8/1246; C01G 15/006; C01P 2006/80; C01P 2002/34; C01P 2006/40; C01P 2002/50

(57) ABSTRACT

This invention relates to a single-phase perovskite-based solid electrolyte, a solid oxide fuel cell including the same, and a method of manufacturing the same. The method of the invention includes stirring and pulverizing a mixed oxide including lanthanum oxide (La₂O₃), strontium carbonate (SrCO₃), gallium oxide (Ga₂O₃) and magnesium oxide (MgO); and obtaining an LSGM powder by subjecting the pulverized mixed oxide to primary calcination at a first temperature and then secondary calcination at a second temperature that is higher than the first temperature.

### TECHNICAL FIELD

The present invention relates to a solid electrolyte for use in a solid oxide fuel cell, and more particularly to a single-phase perovskite-based solid electrolyte, a solid oxide fuel cell comprising the same, and a method of manufacturing the same, in which LSGM having a mixed structure is manufactured in the form of a single-phase structure, and power output characteristics of the solid oxide fuel cell may be improved.

### BACKGROUND ART

A solid oxide fuel cell (SOFC) is configured such that unit cells (anode/electrolyte/cathode) that cause an electrochemical reaction are stacked to a size corresponding to a required capacity, and is typically operated at a high temperature ranging from 800° C. to 1,000° C. Mainly useful as a solid electrolyte of the SOFC is fluorite-structured yttria-stabilized zirconia (YSZ). When YSZ operates at high temperatures of 900° C. or more, it is able to maintain high ionic conductivity and long-term stability, but causes changes in microstructure of the cell due to the operation at high temperatures and the use of an expensive interconnector for supplying fuel and thus limitations are imposed on increasing reliability of product quality and reducing manufacturing costs.

Hence, recent research is ongoing into lowering the operating temperature of an SOFC to 800° C. or less so as to increase the durability of the SOFC and reduce the manufacturing cost thereof.

Lowering the operating temperature of the SOFC may include reducing the thickness of an electrolyte to thus decrease resistance and forming an electrode-supported structure, and the use of a solid electrolyte having high ionic conductivity even at a middle- or low-temperature of 800° C. or less. These days, a perovskite-structured solid electrolyte is under study. The perovskite-structured solid electrolyte exhibits high ionic conductivity of about 0.16 S/cm at 800° C., but has reactivity with NiO, which constitutes the anode reaction layer, and a design for controlling the formation of abnormal materials (impurities) due to such reactivity and a manufacturing technique thereof are limited.

Meanwhile, a conventional perovskite-based solid electrolyte may have a composition of La₁₋ₓSrₓGa_{1-y-z}Mg_{y}M_{z}O_{3-δ} (M=Fe, Co, etc.), composed mainly of an LSGM material comprising La, Sr, Ga, and Mg and further including Co, Fe, etc. to increase ionic conductivity.

Korean Patent No. 10-0777685 discloses a solid oxide electrolyte having ionic conductivity increased to the level of 0.16 S/cm at 800° C. by substituting a LaGaO₃ composition, containing Sr and Mg replaced in amounts of 20 mol % or more, with a trace amount of Fe. Based on most XRD results, LaSrO₄ or MgO peaks, which are secondary-phase impurities, are observed, and the synthesis of a single-phase perovskite-structured material does not appear, and furthermore, the solid electrolyte layer using the above material and the manufacturing process and performance of the SOFC including the same are not mentioned therein.

Also, Korean Patent No. 10-1100349 discloses the use of a La_{0.8}Sr_{0.2}Ga_{0.8}Mg_{0.2}O_{2.8} composition with an additive for a sintering process in the temperature range of 1,200° C. to 1,300° C., but based on the results of XRD, many LaSrGaO₄ impurity peaks, other than LSGM, are observed, and the results of evaluation of ionic conductivity and cell performance are not confirmed.

U.S. Pat. No. 6,004,688 discloses an LSGM-based solid electrolyte having ionic conductivity in a wide range of 0.079 to 0.16 S/cm at 800° C., and also discloses an electrolyte-supported SOFC unit cell having power output characteristics of a maximum of 0.54 W/cm², but the above patent does not show the XRD results of the LSGM material used therefor and is considered mainly useful as the essential patent of the composition.

The conventional techniques having the above configuration may include GNP (Glycine Nitrate Process), a Pechini process and a solid reaction process. Based on the results of analysis of the synthesized LSGM material, the single-phase powder is not completely synthesized, and variations in ionic conductivity may increase depending on the amount of secondary phase and impurities contained therein.

The LSGM material is problematic because it may react with NiO for the anode and thus La³⁺ or Ni²⁺ ions are diffused into the anode, undesirably producing a non-conductor LaNiO₃. Hence, a buffer layer that suppresses the reaction is required.

As for the conventional techniques, in the case of an electrolyte-supported type, a thick solid electrolyte layer is molded using a pressing mold and sintered, after which a buffer layer, an anode reaction layer and a cathode are applied through screen printing and then sintered. In the case of an anode-supported type, an anode diffusion layer is press-molded and sintered, and an anode reaction layer, a buffer layer, a solid electrolyte layer, and a cathode layer are sequentially applied through screen printing. Here, sintering is required for each process and thus has to be performed a total of about four to five times, thereby greatly increasing the manufacturing cost, making it difficult to control the microstructure due to the repeated sintering processes, and deteriorating the molding quality.

### DISCLOSURE

### Technical Problem

Accordingly, the present invention has been made keeping in mind the problems encountered in the related art, and the present invention is intended to provide a method of manufacturing a single-phase perovskite-based solid electrolyte, wherein a single-phase powder is completely synthesized and ionic conductivity may be improved.

Also, the present invention is intended to provide a solid oxide fuel cell (SOFC) and a method of manufacturing the same, wherein the cost of manufacturing the SOFC is decreased, and the SOFC has superior ionic conductivity and power output characteristics.

### Technical Solution

An aspect of the present invention provides a method of manufacturing a single-phase perovskite-based solid electrolyte, comprising: stirring and pulverizing a mixed oxide comprising lanthanum oxide (La₂O₃), strontium carbonate (SrCO₃), gallium oxide (Ga₂O₃) and magnesium oxide (MgO); and obtaining an LSGM powder by subjecting the pulverized mixed oxide to primary calcination at a first temperature and then to secondary calcination at a second temperature that is higher than the first temperature.

In the present invention, the LSGM powder may have a composition of La_{0.8}Sr_{0.2}Ga_{0.8}Mg_{0.2}O_{3-δ} (0≤δ≤0.2).

In the present invention, lanthanum oxide (La₂O₃) may have a purity of 99.99% or more, strontium carbonate (SrCO₃) may have a purity of 99.7% or more, gallium oxide (Ga₂O₃) may have a purity of 99.0% or more, and magnesium oxide (MgO) may have a purity of 99.0% or more.

In the present invention, the mixed oxide may comprise 100 parts by weight of lanthanum oxide (La₂O₃), 15 to 30 parts by weight of strontium carbonate (SrCO₃), 50 to 65 parts by weight of gallium oxide (Ga₂O₃), and 3 to 9 parts by weight of magnesium oxide (MgO), which are mixed together.

In the present invention, the stirring and pulverizing the mixed oxide may further comprise: subjecting the mixed oxide to planetary ball milling in a zirconia container containing zircon balls and then to pulverization using a mortar and pestle.

In the present invention, the method may further comprise subjecting the mixed oxide to planetary ball milling and then to pulverization using a mortar and pestle, after the primary calcination and before the secondary calcination.

In the present invention, the method may further comprise subjecting the mixed oxide to planetary ball milling and then to pulverization using a mortar and pestle, after the secondary calcination.

In the present invention, the first temperature may range from 900° C. to 1,200° C. and the second temperature may range from 1,400° C. to 1, 600° C.

In the present invention, lanthanum oxide (La₂O₃) may be thermally treated at 800° C. to 1,300° C. before use and maintained in an atmosphere that blocks a reaction with water in order to prevent conversion into La(OH)₃.

Another aspect of the present invention provides a method of manufacturing a solid oxide fuel cell, comprising: preparing an anode diffusion layer slurry and an anode reaction layer slurry using NiO, GDC (Gadolinia-Doped Ceria) and a carbon material; preparing a buffer layer slurry using LDC (Lanthanum-Doped Ceria); preparing an electrolyte layer slurry using the LSGM powder of the invention; subjecting the anode diffusion layer slurry, the anode reaction layer slurry, the buffer layer slurry and the electrolyte layer slurry to tape casting to form respective films, which are then sequentially stacked, thus obtaining an anode-supported electrolyte assembly; manufacturing an anode-supported electrolyte-sintered assembly by subjecting the anode-supported electrolyte assembly to primary calcination at a first temperature and then to secondary calcination at a second temperature higher than the first temperature; and applying a cathode slurry comprising LSCF (Lanthanum-Strontium-Cobalt-Ferrite Oxide) and the LSGM powder on the anode-supported electrolyte-sintered assembly and then performing sintering.

The preparing the anode diffusion layer slurry and the anode reaction layer slurry may further comprise: mixing zircon balls, NiO, GDC, the carbon material, toluene, ethanol, and a dispersant in a container, thus obtaining a mixed solution; and mixing the mixed solution with a binder solution.

The anode diffusion layer slurry may comprise 100 parts by weight of NiO, 62 to 72 parts by weight of GDC, 10 to 47 parts by weight of the carbon material, 75 to 110 parts by weight of toluene, 50 to 70 parts by weight of ethanol, 3 to 5 parts by weight of the dispersant, and 75 to 95 parts by weight of the binder solution.

The anode reaction layer slurry may comprise 100 parts by weight of NiO, 62 to 72 parts by weight of GDC, 0 to 30 parts by weight of the carbon material, 70 to 90 parts by weight of toluene, 45 to 65 parts by weight of ethanol, 2 to 6 parts by weight of the dispersant, and 60 to 95 parts by weight of the binder solution.

The preparing the buffer layer slurry may further comprise: providing LDC, toluene, ethanol, a dispersant and a binder solution so as to comprise 100 parts by weight of LDC, 75 to 85 parts by weight of toluene, 15 to 25 parts by weight of ethanol, 0.5 to 1.5 parts by weight of the dispersant, and 45 to 55 parts by weight of the binder solution, and mixing zircon balls, LDC, toluene, ethanol and the dispersant in a container, thus obtaining a mixed solution; and mixing the mixed solution with the binder solution.

The preparing the electrolyte layer slurry may further comprise: providing the LSGM powder, toluene, ethanol, a dispersant and a binder solution so as to comprise 100 parts by weight of the LSGM powder, 75 to 85 parts by weight of toluene, 15 to 25 parts by weight of ethanol, 0.5 to 1.5 parts by weight of the dispersant, and 45 to 55 parts by weight of the binder solution and mixing zircon balls, the LSGM powder, toluene, ethanol and the dispersant in a container, thus obtaining a mixed solution; and mixing the mixed solution with the binder solution.

The cathode slurry may comprise 100 parts by weight of LSCF, 95 to 105 parts by weight of LSGM, 76 to 90 parts by weight of terpineol, and 3 to 15 parts by weight of ethylene cellulose.

Still another aspect of the present invention provides a solid oxide fuel cell, comprising: an anode diffusion layer comprising NiO, GDC and a carbon material; an anode reaction layer formed on the anode diffusion layer and comprising NiO, GDC and the carbon material; a buffer layer formed on the anode reaction layer and comprising LDC; an electrolyte layer formed on the buffer layer and comprising an LSGM powder; and a cathode formed on the electrolyte layer and comprising LSCF and the LSGM powder.

### Advantageous Effects

According to the present invention, a single-phase cubic LSGM powder having few impurity peaks and high ionic conductivity can be manufactured by mixing lanthanum oxide, strontium carbonate, gallium oxide and magnesium oxide, followed by subjecting the resulting mixture to primary calcination at a first temperature and pulverization and then to secondary calcination at a second temperature, higher than the first temperature, and pulverization.

Also, according to the present invention, an SOFC can be manufactured in a manner in which an anode diffusion layer, an anode reaction layer, a buffer layer and an electrolyte layer are provided in the form of a film and respective films are then stacked. Hence, an additional sintering process is obviated during the stacking of the anode diffusion layer, the anode reaction layer, the buffer layer and the electrolyte layer, thus reducing the processing cost required for the sintering process and obtaining superior ionic conductivity and power output characteristics because of the use of the single-phase LSGM powder having low resistance.

### DESCRIPTION OF DRAWINGS

FIG. 1 shows a process of manufacturing a single-phase perovskite-based solid electrolyte according to an embodiment of the present invention;

FIG. 2 is a graph showing thermal properties of an LSGM powder after ball milling and immediately before primary calcination;

FIG. 3 is a graph showing XRD properties of the powder thermally treated at intervals of 100° C. in the temperature range of 500 to 1,500° C.;

FIG. 4 is a graph showing the lattice constant and the crystal size as results of Rietveld analysis of the powder thermally treated at intervals of 100° C. in the temperature range of 500 to 1,500° C.;

FIG. 5 is a graph showing XRD properties of the LSGM powder depending on the first calcination temperature and the second calcination temperature;

FIG. 6 shows SEMs of the LSGM powder after secondary calcination;

FIG. 7 is a graph showing the results of measurement of ionic conductivity of the LSGM powder;

FIG. 8 shows the configuration of an SOFC according to an embodiment of the present invention;

FIG. 9 shows films obtained through tape casting using the LSGM powder;

FIG. 10 shows the cross-section of an SOFC cell using the LSGM powder;

FIG. 11 is a graph showing the power output characteristics of the SOFC cell using the LSGM powder; and

FIG. 12 is a graph showing the impedance characteristics of the SOFC using the LSGM powder.

### BEST MODE

Hereinafter, preferred embodiments of the present invention will be described in detail with reference to the accompanying drawings so that the present invention is easily embodied by those skilled in the art to which the present invention belongs. Further, when any portion ‘includes’ any component, this means that the portion does not exclude other components, but may further include other components unless otherwise stated.

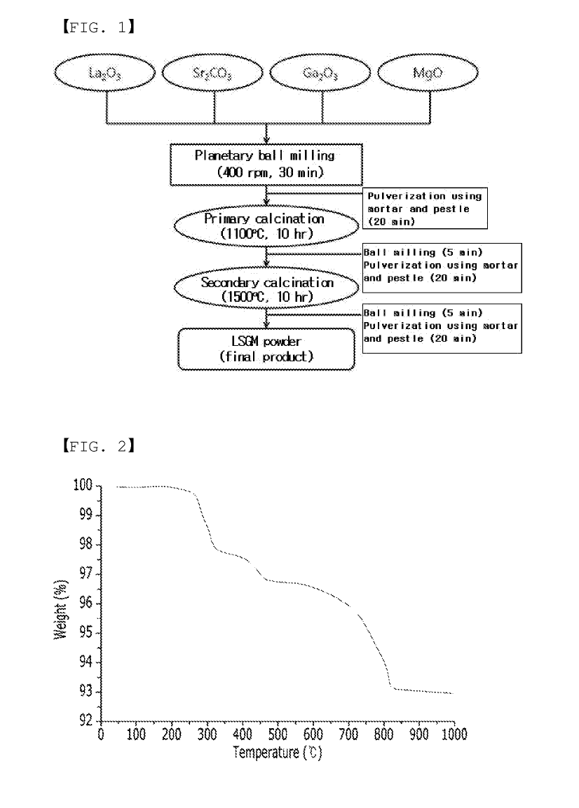

FIG. 1 shows the process of manufacturing a single-phase perovskite-based solid electrolyte according to an embodiment of the present invention.

As shown in FIG. 1, the method of manufacturing the single-phase perovskite-based solid electrolyte according to an embodiment of the present invention includes mixing lanthanum oxide (La₂O₃), strontium carbonate (SrCO₃), gallium oxide (Ga₂O₃) and magnesium oxide (MgO), stirring and pulverizing the mixed oxide using a mechanical process such as planetary ball milling, performing primary calcination at about 900° C. to 1,200° C., planetary ball milling and pulverization, and performing secondary calcination at 1,500° C. to 1,600° C., planetary ball milling and pulverization, thus producing an LSGM powder.

Here, the LSGM powder has a composition of La_{0.8}Sr_{0.2}Ga_{0.8}Mg_{0.2}O_{3-δ} (0≤δ≤0.2).

The purity of lanthanum oxide (La₂O₃) is 99.99% or more, the purity of strontium carbonate (SrCO₃) is 99.7% or more, the purity of gallium oxide (Ga₂O₃) is 99.0% or more, and the purity of magnesium oxide (MgO) is 99.0% or more, which is relatively low. Thus, the method of manufacturing the single-phase perovskite-based solid electrolyte according to the present invention is capable of synthesizing the single-phase perovskite-based solid electrolyte at low cost.

The mixed oxide is composed of lanthanum oxide (La₂O₃), strontium carbonate (SrCO₃), gallium oxide (Ga₂O₃) and magnesium oxide (MgO), in which 100 parts by weight of lanthanum oxide (La₂O₃), 15 to 30 parts by weight and preferably 23 parts by weight of strontium carbonate (SrCO₃), 50 to 65 parts by weight and preferably 58 parts by weight of gallium oxide (Ga₂O₃), and 3 to 9 parts by weight and preferably 6 parts by weight of magnesium oxide (MgO) are mixed together.

When lanthanum oxide (La₂O₃) having a purity of 99.99% or more is stored in air, it may be converted into La(OH)₃, and hence, it must be sufficiently thermally treated at about 800° C. to 1,300° C. for a period of time ranging from ones of min to tens of hour immediately before being used, and has to be maintained in an atmosphere that blocks the reaction with water (moisture).

As mentioned above, the calcination process is performed through two steps in the present invention. The reason is as follows. When the LSGM powder is prepared through a single calcination process, particles are non-uniformly formed, making it impossible to control the particle shape and the crystal size. According to the present invention, however, when intermediate pyrolysis such as primary calcination and milling are performed, it is easy to control the particle shape and the crystal size of the final LSGM powder. Hence, the two-step calcination process is carried out in the present invention.

Also, secondary calcination is able to obtain a single-phase cubic LSGM powder having an appropriate crystal size, superior ionic conductivity, and few impurity peaks, and is preferably performed at a temperature ranging from 1,400° C. to 1,600° C. in order to reduce the processing cost upon preparation of the LSGM powder.

The process of manufacturing an electrolyte layer film by means of a tape-casting device using the LSGM powder obtained by the method of manufacturing the single-phase perovskite-based solid electrolyte is described below.

100 parts by weight of the LSGM powder obtained by the method of manufacturing the single-phase perovskite-based solid electrolyte as above, 75 to 85 parts by weight and preferably 80 parts by weight of toluene, 15 to 25 parts by weight and preferably 20 parts by weight of ethanol, 0.5 to 1.5 parts by weight and preferably 1.0 part by weight of a dispersant, and 45 to 55 parts by weight and preferably 50 parts by weight of a binder solution are mixed, thus affording an electrolyte layer slurry. Here, the mixing sequence of the materials may vary as needed, but it is preferred that the LSGM powder, toluene, ethanol, and dispersant be mixed first for a predetermined period of time and that the binder solution then be further added and stirred.

The electrolyte layer slurry comprising the LSGM powder, toluene, ethanol, dispersant and binder solution thus mixed may be manufactured into a film having a thickness of 5 to 300 μm at a rate of 0.3 to 1.2 m/min using a tape-casting device, and preferably a film having a thickness of 10 to 100 μm so as to be suitable for desired performance of the SOFC.

Meanwhile, when the anode-supported electrolyte assembly (anode diffusion layer/anode reaction layer/buffer layer/electrolyte layer) of the SOFC cell is manufactured using a tape-casting device, each of the anode diffusion layer, the anode reaction layer, the buffer layer and the electrolyte layer is prepared in the form of a slurry and is then manufactured into a film using a tape-casting device.

Specifically, the anode diffusion layer slurry is composed of commercially available NiO (J. T. Backer) and GDC (Gadolinia-Doped Ceria, BET: 7.7 m²/g, Fuel Cell Materials), a carbon material (e.g. carbon black), toluene, ethanol, a dispersant and a binder solution, and is configured to include NiO in an amount of 100 parts by weight, GDC in an amount of 62 to 72 parts by weight and preferably 67 parts by weight, carbon black in an amount of 10 to 47 parts by weight and preferably 42 parts by weight, toluene in an amount of 75 to 110 parts by weight and preferably 96 parts by weight, ethanol in an amount of 50 to 70 parts by weight and preferably 64 parts by weight, the dispersant in an amount of 3 to 5 parts by weight and preferably 4 parts by weight, and the binder solution in an amount of 75 to 95 parts by weight and preferably 90 parts by weight.

Also, the anode reaction layer slurry is composed of commercially available NiO (J. T. Backer) and GDC (BET: 7.7 m²/g, Fuel Cell Materials), a carbon material (e.g. carbon black), toluene, ethanol, a dispersant and a binder solution, and is configured to include NiO in an amount of 100 parts by weight, GDC in an amount of 62 to 72 parts by weight and preferably 67 parts by weight, carbon black in an amount of 0 to 30 parts by weight and preferably 19 parts by weight, toluene in an amount of 70 to 90 parts by weight and preferably 85 parts by weight, ethanol in an amount of 45 to 65 parts by weight and preferably 57 parts by weight, the dispersant in an amount of 2 to 6 parts by weight and preferably 4 parts by weight, and the binder solution in an amount of 60 to 95 parts by weight and preferably 82 parts by weight.

Also, the buffer layer slurry is composed of LDC (Lanthanum-Doped Ceria, BET: 10 m²/g, Kceracell), toluene, ethanol, a dispersant and a binder solution, and is configured to include LDC in an amount of 100 parts by weight, toluene in an amount of 75 to 85 parts by weight and preferably 80 parts by weight, ethanol in an amount of 15 to 25 parts by weight and preferably 20 parts by weight, the dispersant in an amount of 0.5 to 1.5 parts by weight and preferably 1 part by weight, and the binder solution in an amount of 45 to 55 parts by weight and preferably 50 parts by weight.

Each of the anode diffusion layer slurry, the anode reaction layer slurry and the buffer layer slurry is manufactured into a film having a thickness of 5 to 300 μm at a rate of 0.3 to 1.2 m/min using a tape-casting device, and each of the anode diffusion layer and the anode reaction layer is preferably formed into a film having a thickness of 30 to 60 μm, and the LDC film is preferably formed to a thickness of 5 to 20 μm.

After the formation of respective films of the anode diffusion layer, the anode reaction layer, the buffer layer and the electrolyte layer, the anode reaction layer, buffer layer and electrolyte layer films are sequentially stacked on the anode diffusion layer and then lamination is performed at a predetermined temperature (e.g. 70° C.) under predetermined pressure (e.g. 60 MPa) for tens of min. Here, it is possible to manufacture a high-quality cell without cracking and cleaving by elevating the temperature to 1,000° C. for pre-sintering.

The heating rate in the process of elevating the temperature is set to 1° C./min, and is maintained for ones of hour at each of 150° C., 300° C., 600° C., and 900° C., is finally maintained at 1,000° C. for ones of hour, and then naturally allowed to cool again to room temperature. After the pre-sintering process, the SOFC cell is maintained at a heating rate of 1° C./min, maintained at 1,300° C. to 1,500° C. for ones of hour, and then naturally allowed to cool to room temperature, thereby completing an anode-supported electrolyte assembly.

The cathode slurry is composed of commercially available LSCF (Lanthanum-Strontium-Cobalt-Ferrite Oxide), terpineol, ethylene cellulose and the LSGM powder, and is configured to include LSCF in an amount of 100 parts by weight, LSGM in an amount of 95 to 105 parts by weight and preferably 100 parts by weight, terpineol in an amount of 76 to 90 parts by weight and preferably 81 parts by weight, and ethylene cellulose in an amount of 3 to 15 parts by weight and preferably 9 parts by weight. The cathode slurry thus obtained is sufficiently dispersed using a 3-roll mill, applied to a thickness of to 60 μm on the calcined electrolyte using a screen printer, and sintered at a temperature of 1,000° C. to 1,200° C. for ones of hour, thereby manufacturing an SOFC unit cell.

### MODE FOR INVENTION

### Example 1

Synthesis of Single-Phase LSGM Powder

As starting materials, lanthanum oxide (La₂O₃, Grand Chemical & Material CO., LTD, 99.99%, FW: 325.84), strontium carbonate (SrCO₃, Grand Chemical & Material CO., LTD, 99.7%, FW: 147.78), gallium oxide (Ga₂O₃, MINING & CHEMICAL PRODUCTS, LTD, 99.00%, FW: 189.34), and magnesium oxide (MgO, KANTO CHEMICAL CO., INC, 99.00%, FW: 40.71) were provided and mixed at a weight ratio (wt %) of La₂O₃ to SrCO₃ to Ga₂O₃ to MgO of 54:12:31:3.

The mixture comprising lanthanum oxide, strontium carbonate, gallium oxide and magnesium oxide were placed in a 500 ml zirconia container together with 50 zircon balls having a size of 10 mm, and subjected to planetary ball milling (FRITCH, Pulverisette, Germany) at 400 rpm for 30 min and then to primary pulverization using a mortar and pestle for 20 min.

The powder thus pulverized was subjected to primary calcination comprising elevating the temperature to 1,100° C. at a heating rate of 5° C./min and maintaining the elevated temperature for 10 hrs, after which planetary ball milling was performed for 5 min and then secondary pulverization was carried out for 20 min using a mortar and pestle.

The secondarily pulverized powder was subjected to secondary calcination comprising elevating the temperature to 1,500° C. at a heating rate of 5° C./min and maintaining the elevated temperature for 10 h, after which planetary ball milling was performed for 5 min and then tertiary pulverization was conducted for 20 min using a mortar and pestle. Thereby, the LSGM powder of the present invention was obtained.

During the primary and secondary calcinations, it is preferred that the structure and shape of the container be taken into consideration so as to realize efficient contact of particles of the powder to increase the reactivity based on solid reaction.

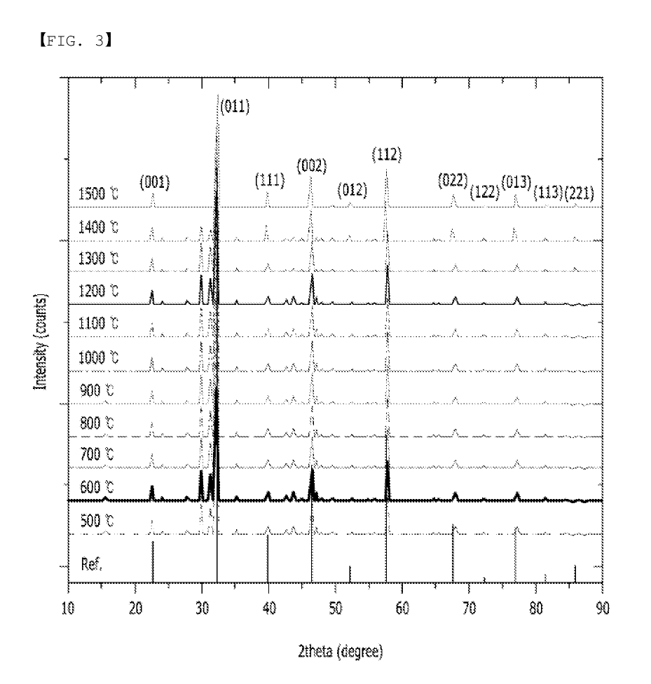

FIG. 2 is a graph showing the thermal properties of the mixed powder after ball milling and immediately before primary calcination in the above LSGM manufacturing process. As shown in FIG. 2, the weight was remarkably reduced by about 7 wt % through solid reaction up to 820° C., and slightly reduced at a temperature higher than that. Hence, this material can be found to be crystallized at 800° C. or more.

Based on the results of measurement of XRD of the powder thermally treated at intervals of 100° C. in the temperature range from 500° C. to 1,500° C., as shown in FIG. 3, many impurity peaks were observed up to 1,400° C. but a single-phase cubic LSGM powder having few impurity peaks was formed at 1,500° C.

As mentioned above, when the LSGM powder is prepared through single thermal treatment (i.e. calcination), the single-phase LSGM powder may be obtained, but the particles are non-uniform, making it difficult to control the particle shape and the crystal size. In the present invention, the LSGM powder was manufactured through two calcinations.

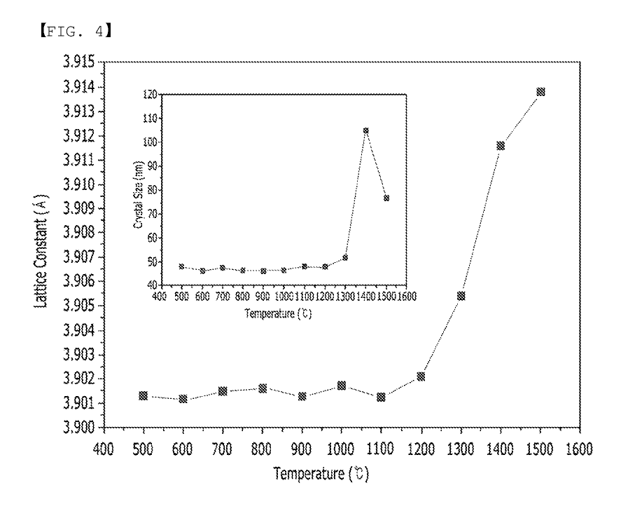

As shown in FIG. 4, based on the results of Rietveld analysis, the lattice constant was maintained close to the level of about 3.091 up to the calcination temperature of 1,200° C., drastically increased from 1,300° C., and raised to 3.914 at 1,500° C., and the crystal size was about 45 to 50 nm up to 1,300° C. and increased to the level of 70 to 100 nm at 1,400 to 1,500° C.

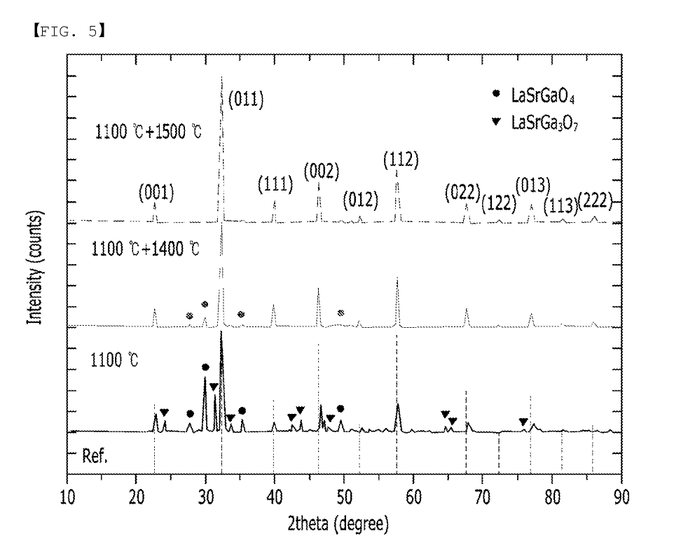

As for the XRD properties of the LSGM powder depending on the primary calcination temperature (1,100° C.) and the secondary calcination temperature (1,400° C. and 1,500° C.), as shown in FIG. 5, a large number of peaks of impurities such as LaSrGaO₄ or LaSrGa₃O₇ (i.e. secondary phase) were observed in the primarily calcined powder, but the LaSrGa₃O₇ impurity peak disappeared and only the LaSrGaO₄ impurity peak was detected at low intensity after the secondary calcination at 1,400° C., and the powder secondarily calcined at 1,500° C. was provided in the form of a single phase having no impurities.

As shown in FIG. 6, after the secondary calcination at 1,500° C., the secondary particles were pulverized to about 5 μm, and the secondary particles were configured such that the primary particles having a size of 50 to 100 nm were very strongly aggregated and sintered. Here, the specific surface area (BET) of the particles was measured to be about 1.42 m²/g, and was thus suitable for use in manufacturing a tape-casting film.

Meanwhile, in order to measure the ionic conductivity of the LSGM (La_{0.8}Sr_{0.2}Ga_{0.8}Mg_{0.2}O_{3-δ}) electrolyte powder thus obtained, a test sample was manufactured through uniaxial pressing. Specifically, the LSGM powder was placed in a cylindrical mold, pressed at a pressure of 60 MPa for 1 hr, heated to 1,500° C. from room temperature at a rate of 5° C./min, and maintained at the elevated temperature for 10 hrs, thus manufacturing a test sample.

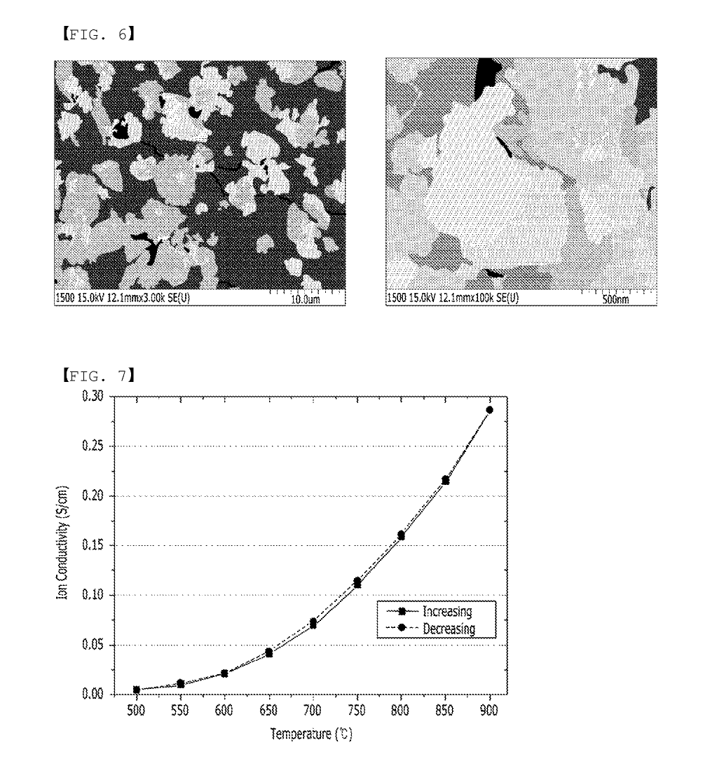

The test sample thus manufactured was mounted into a high-temperature cell (GEFRAN 800P, USA) for measuring ionic conductivity, and connected to an impedance analyzer (Frequency response analyzer, Solatron, solatronl260, USA), after which a resistance value was measured in the temperature range of 500 to 900° C. under conditions of a frequency of 500 kHz-0.1 Hz at an amplitude of 50 mV, thus determining ionic conductivity. As shown in FIG. 7, the ionic conductivity was proportional to an increase or decrease in the temperature, and high ionic conductivity, for example, 0.07 S/cm at 700° C., 0.11 S/cm at 750° C., and 0.16 S/cm at 800° C., was exhibited, and thus there was no great difference in ionic conductivity depending on an increase or decrease in the temperature. This result represented an increase of about 50 to 100% compared to conventional YSZ electrolyte materials or ScSZ-based materials.

### Example 2

SOFC Cell Using LSGM Powder and Manufacture Thereof

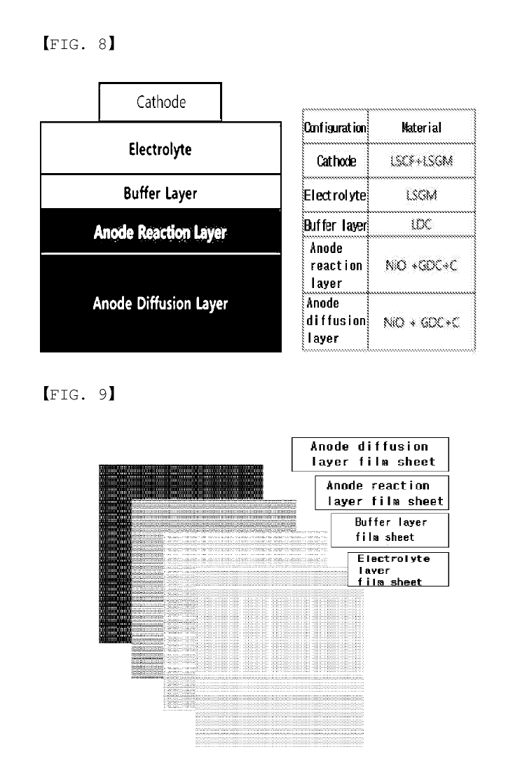

As shown in FIG. 8, an SOFC cell manufactured using the LSGM powder obtained through the aforementioned powder synthesis process is configured such that an anode reaction layer comprising a mixture of NiO, GDC and a carbon material is stacked on an anode diffusion layer comprising a mixture of NiO, GDC and a carbon material (i.e. carbon black), and a buffer layer comprising LDC is stacked on the anode reaction layer. Furthermore, an electrolyte layer is stacked on the buffer layer using the LSGM powder of the present invention, and a cathode comprising a mixture of the LSGM powder of the invention and LSCF is stacked on the electrolyte layer.

The method of manufacturing the SOFC cell having the above configuration according to an embodiment of the present invention is described below.

In order to manufacture an anode diffusion layer, an anode reaction layer, a buffer layer and an electrolyte layer into respective films using a tape-casting device (STC-14C, HANSUNG SYSTEM, Korea), an anode diffusion layer slurry, an anode reaction layer slurry, a buffer layer slurry and an electrolyte layer slurry are first prepared.

Specifically, the anode diffusion layer slurry was prepared in a manner in which 125 zircon balls having a size of 10 mm were placed in a 1 L container, NiO, GDC, and carbon black were added at a ratio of 21.6:14.4:9 wt % based on the total weight of the anode diffusion layer slurry, toluene, ethanol and a dispersant were added at a ratio of 20.7:13.9:0.9 wt % based on the total weight of the anode diffusion layer slurry, the added components were mixed for 24 husing a two-stage ball mill, and the resulting mixed solution was added with a binder solution in an amount of 19.5 wt % based on the total weight of the anode diffusion layer slurry, followed by additional mixing for 24 hr.

The anode reaction layer slurry was prepared in a manner in which 125 zircon balls having a size of 10 mm were placed in a 1 L container, NiO, GDC, and carbon black were added at a ratio of 24.3:16.2:4.5 wt % based on the total weight of the anode reaction layer slurry, toluene, ethanol and a dispersant were added at a ratio of 20.7:13.9:0.9 wt % based on the total weight of the anode reaction layer slurry, the added components were mixed for 24 h using a two-stage ball mill, and the resulting mixed solution was added with a binder solution in an amount of 19.5 wt % based on the total weight of the anode reaction layer slurry, followed by additional mixing for 24 hr.

The buffer layer slurry was prepared in a manner in which 94 zircon balls having a size of 10 mm were placed in a 500 ml container, LDC (BET: 10 m²/g, Kceracell) was added in an amount of 40 wt % based on the total weight of the buffer layer slurry, toluene, ethanol and a dispersant were added at a ratio of 31.8:7.98:0.36 wt % based on the total weight of the buffer layer slurry, the added components were mixed for 24 h using a two-stage ball mill, and the resulting mixed solution was added with a binder solution in an amount of 19.86 wt % based on the total weight of the buffer layer slurry, followed by additional mixing for 24 hr.

Finally, the electrolyte layer slurry was prepared in a manner in which 94 zircon balls having a size of 10 mm were placed in a 500 ml container, an LSGM powder was added in an amount of 40 wt % based on the total weight of the electrolyte layer slurry, toluene, ethanol and a dispersant were added at a ratio of 31.8:7.98:0.36 wt % based on the total weight of the electrolyte layer slurry, the added components were mixed for 24 h using a two-stage ball mill, and the resulting mixed solution was added with a binder solution in an amount of 19.86 wt % based on the total weight of the electrolyte layer slurry, followed by additional mixing for 24 hr.

After the preparation of the anode diffusion layer slurry, the anode reaction layer slurry, the buffer layer slurry and the electrolyte layer slurry as described above, an anode diffusion layer film, an anode reaction layer film, a buffer layer film and an electrolyte layer film are manufactured using a tape-casting device.

To obtain the anode diffusion layer film and the anode reaction layer film, a doctor blade of the tape-casting device was adjusted to a height of 230 μm, and casting was performed at a rate of 0.12 m/min at 80° C. Accordingly, an anode diffusion layer film and an anode reaction layer film each having a thickness of about 45 μm could be obtained.

To obtain the buffer layer film, the height of the doctor blade was adjusted to about 100 μm, and casting was performed at a rate of 0.12 m/min at 80° C. Accordingly, a buffer layer film having a thickness of about 10 μm could be obtained.

To obtain the electrolyte layer film, the height of the doctor blade was adjusted to about 250 μm, and casting was performed at a rate of 0.12 m/min at 80° C. Accordingly, an electrolyte layer film having a thickness of 20 to 22 μm could be obtained.

When the tape-casting device is used in this way, the anode diffusion layer, the anode reaction layer, the buffer layer and the electrolyte layer may be manufactured in the form of a thin film having a thickness of 10 to 100 μm, as shown in FIG. 9.

After the completion of the formation of the anode diffusion layer film, the anode reaction layer film, the buffer layer film and the electrolyte layer film, 40 to 60 anode diffusion layer films were stacked to a thickness of about 1 to 1.5 mm, and a single anode reaction layer film and a single buffer layer film were sequentially placed on the uppermost anode diffusion layer film.

On a green sheet comprising the anode diffusion layers, the anode reaction layer and the buffer layer, four LSGM electrolyte films were stacked, thus completing an anode-supported electrolyte assembly, after which the green assembly was subjected to lamination at a temperature of 70° C. and a pressure of 60 MPa for about 20 min and then molded using a cylindrical mold having a diameter of 2.5 cm, thereby fabricating an anode-supported electrolyte-integrated film.

The anode-supported electrolyte-integrated film thus fabricated was placed on an alumina plate having controlled reactivity, transferred into a furnace having an appropriate size, and then primarily calcined by elevating the temperature from room temperature to 1,000° C. The temperature was elevated in a manner in which the temperature was maintained at 150° C. for 2 h, at 300° C. for 2 h, at 600° C. for 2 h, at 900° C. for 2 h, and at 1,000° C. for 3 hr. After the primary calcination process, a secondary calcination process was performed by elevating the temperature from room temperature to 1,400° C. and then maintaining the elevated temperature for 3 h, ultimately manufacturing an anode-supported electrolyte-sintered assembly through simultaneous sintering. Here, the heating rate necessary to reach individual sintering temperatures may be set to either 0.5° C./min or 1.0° C./min.

After the completion of the manufacture of the anode-supported electrolyte-sintered assembly in this way, a cathode was stacked on the anode-supported electrolyte-sintered assembly.

The cathode was first prepared in the form of a slurry. Specifically, an LSGM powder, LSCF, terpineol and ethyl cellulose were placed in a beaker at a ratio of 35:35:28.2:1.8 wt % based on the total weight of the cathode slurry, mixed at room temperature for 24 h using a stirrer, and then further mixed three to four times using a 3-roll mill (EXAKT, Germany), thus preparing a cathode slurry having high viscosity.

After the preparation of the cathode slurry in this way, the anode-supported electrolyte-sintered assembly was fixed to a screen printer (HSP-2C, HANSUNG SYSTEM, Korea), the cathode slurry having high viscosity was applied to a thickness of 40 to 50 μm on the screen printer having a predetermined size, and then the unit cell coated with the cathode slurry was sintered at a temperature of 1,100° C. for 3 h, thus manufacturing an SOFC. Here, the heating rate during the sintering of the cathode was maintained at 5.0° C./min.

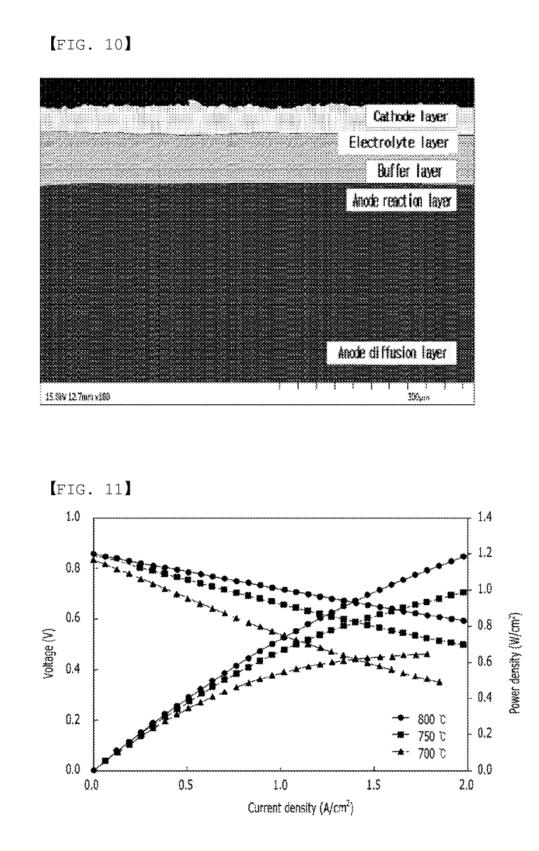

As shown in FIG. 10, the SOFC thus manufactured was configured such that four film layers (i.e. the anode diffusion layer, the anode reaction layer, the buffer layer, and the electrolyte layer) formed through tape casting were very uniformly and efficiently adhered, and the thickness of each layer was uniformly maintained. Furthermore, the electrolyte layer and the cathode layer were in good contact with each other.

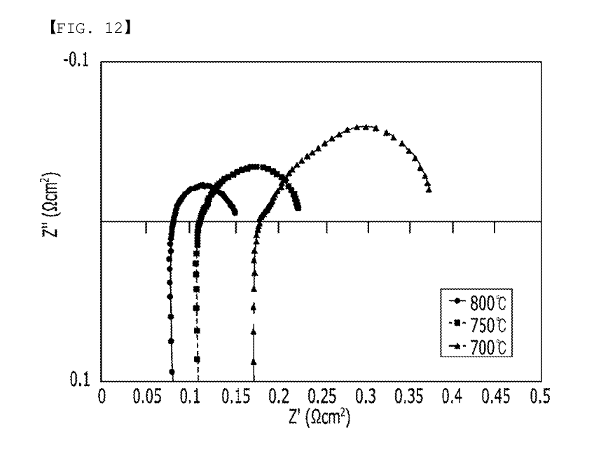

As for the current-voltage characteristics of the SOFC manufactured according to the present invention, as shown in FIG. 11, the open-circuit voltage was about 0.83 V, and was almost the same even at different operating temperatures, and power output performance was increased with an increase in the operating temperature. Specifically, the maximum power output at 700° C. was about 0.65 W/cm². When the current density was 2.0 A/cm² at operating temperatures of 750° C. and 800° C., respective power output characteristics of 1.0 W/cm² and 1.2 W/cm² were exhibited.

Therefore, it can be confirmed that LSGM having high ionic conductivity is applied to a solid electrolyte, which is then manufactured into a unit cell through tape casting, thereby obtaining an SOFC having excellent power output characteristics.

Also, the impedance of the SOFC of the present invention was measured in the open-circuit voltage state depending on the operating temperature. As shown in FIG. 12, the ohmic resistance of the solid electrolyte and the polarization resistance of the electrode were decreased with an increase in the operating temperature. In particular, the ohmic resistance and the polarization resistance were very low, to levels of 0.08 Ω·cm and 0.07 Ω·cm respectively, at an operating temperature of 800° C. However, when the operating temperature was increased to 750° C. and 800° C., the ohmic resistance values were 0.12 Ω·cm and 0.79 Ω·cm, respectively, and the polarization resistance values were 0.11 Ω·cm and 0.19 Ω·cm, respectively, which are evaluated to be proportionally increased. Such ohmic resistance and polarization resistance results were superior to those of conventional solid electrolytes. Therefore, the SOFC of the present invention can be found to exhibit excellent power output characteristics even at low open-circuit voltage.

In the method of manufacturing the single-phase perovskite-based solid electrolyte according to an embodiment of the present invention, lanthanum oxide, strontium carbonate, gallium oxide and magnesium oxide are mixed, and the resulting mixture is primarily calcined at a first temperature and pulverized and then secondarily calcined at a second temperature higher than the first temperature and pulverized, thereby enabling the formation of a single-phase cubic LSGM powder having few impurity peaks and high ionic conductivity.

Also, according to the present invention, the anode diffusion layer, the anode reaction layer, the buffer layer and the electrolyte layer are provided in the form of a film, and respective films are stacked, thus manufacturing an SOFC. Here, an additional sintering process is obviated during the stacking of the anode diffusion layer, the anode reaction layer, the buffer layer and the electrolyte layer, thus reducing the processing cost required for the sintering process and obtaining high ionic conductivity and power output characteristics thanks to the use of single-phase LSGM powder having low resistance.

While the present invention has been described in connection with what is presently considered to be the most practical and preferred embodiment, it is to be understood that the invention is not limited to the disclosed embodiments. It will be apparent to those skilled in the art that various modifications and variations can be made in the present invention without departing from the spirit of the invention. Therefore, the scope of the present invention should not be limited to the embodiments described, but should be defined by the following claims as well as equivalents thereof.

### INDUSTRIAL APPLICABILITY

As described hereinbefore, according to the present invention, a single-phase cubic LSGM powder having few impurity peaks and high ionic conductivity can be obtained in a manner in which lanthanum oxide, strontium carbonate, gallium oxide and magnesium oxide are mixed, and the resulting mixture is primarily calcined at a first temperature and pulverized and then secondarily calcined at a second temperature, higher than the first temperature, and pulverized.

Also, according to the present invention, an SOFC can be manufactured in a manner in which an anode diffusion layer, an anode reaction layer, a buffer layer and an electrolyte layer are provided in the form of a film and respective films are then stacked. Here, an additional sintering process is obviated during the stacking of the anode diffusion layer, the anode reaction layer, the buffer layer and the electrolyte layer, thus reducing the processing cost required for the sintering process and attaining superior ionic conductivity and power output characteristics by the use of the single-phase LSGM powder having low resistance.

1. A method of manufacturing a single-phase perovskite-based solid electrolyte, comprising:
stirring and pulverizing a mixed oxide comprising lanthanum oxide (La₂O₃), strontium carbonate (SrCO₃), gallium oxide (Ga₂O₃) and magnesium oxide (MgO); and
obtaining an LSGM powder by subjecting the pulverized mixed oxide to primary calcination at a first temperature and then to secondary calcination at a second temperature that is higher than the first temperature.

2. The method of claim 1, wherein the LSGM powder has a composition of La_{0.8}Sr_{0.2}Ga_{0.8}Mg_{0.2}O_{3-δ} (0≤δ≤0.2).

3. The method of claim 1, wherein the lanthanum oxide (La₂O₃) has a purity of 99.99% or more, the strontium carbonate (SrCO₃) has a purity of 99.7% or more, the gallium oxide (Ga₂O₃) has a purity of 99.0% or more, and the magnesium oxide (MgO) has a purity of 99.0% or more.

4. The method of claim 1, wherein the mixed oxide comprises 100 parts by weight of the lanthanum oxide (La₂O₃), 15 to 30 parts by weight of the strontium carbonate (SrCO₃), 50 to 65 parts by weight of the gallium oxide (Ga₂O₃), and 3 to 9 parts by weight of the magnesium oxide (MgO), which are mixed together.

5. The method of claim 1, wherein the stirring and pulverizing the mixed oxide further comprises:
subjecting the mixed oxide to planetary ball milling in a zirconia container containing zircon balls and then to pulverization using a mortar and pestle.

6. The method of claim 1, further comprising subjecting the mixed oxide to planetary ball milling and then to pulverization using a mortar and pestle, after the primary calcination and before the secondary calcination.

7. The method of claim 1, further comprising subjecting the mixed oxide to planetary ball milling and then to pulverization using a mortar and pestle, after the secondary calcination.

8. The method of claim 1, wherein the first temperature ranges from 900° C. to 1,200° C. and the second temperature ranges from 1,400° C. to 1,600° C.

9. The method of claim 1, wherein the lanthanum oxide (La₂O₃) is thermally treated at 800° C. to 1,300° C. and maintained in an atmosphere that blocks a reaction with water in order to prevent conversion into La(OH)₃.

10. A method of manufacturing a solid oxide fuel cell, comprising:
preparing an anode diffusion layer slurry and an anode reaction layer slurry using NiO, GDC (Gadolinia-Doped Ceria) and a carbon material;
preparing a buffer layer slurry using LDC (Lanthanum-Doped Ceria);
preparing an electrolyte layer slurry using an LSGM powder obtained by the method of claim 1;
subjecting the anode diffusion layer slurry, the anode reaction layer slurry, the buffer layer slurry and the electrolyte layer slurry to tape casting to form respective films, which are then sequentially stacked, thus obtaining an anode-supported electrolyte assembly;
manufacturing an anode-supported electrolyte-sintered assembly by subjecting the anode-supported electrolyte assembly to primary calcination at a first temperature and then to secondary calcination at a second temperature higher than the first temperature; and
applying a cathode slurry comprising LSCF (Lanthanum-Strontium-Cobalt-Ferrite Oxide) and the LSGM powder on the anode-supported electrolyte-sintered assembly and then performing sintering.

11. The method of claim 10, wherein the preparing the anode diffusion layer slurry and the anode reaction layer slurry further comprises:
mixing zircon balls, NiO, GDC, the carbon material, toluene, ethanol, and a dispersant in a container, thus obtaining a mixed solution; and
mixing the mixed solution with a binder solution.

12. The method of claim 11, wherein the anode diffusion layer slurry comprises 100 parts by weight of NiO, 62 to 72 parts by weight of GDC, 10 to 47 parts by weight of the carbon material, 75 to 110 parts by weight of toluene, 50 to 70 parts by weight of ethanol, 3 to parts by weight of the dispersant, and 75 to 95 parts by weight of the binder solution.

13. The method of claim 11, wherein the anode reaction layer slurry comprises 100 parts by weight of NiO, 62 to 72 parts by weight of GDC, 0 to 30 parts by weight of the carbon material, 70 to 90 parts by weight of toluene, 45 to 65 parts by weight of ethanol, 2 to 6 parts by weight of the dispersant, and 60 to 95 parts by weight of the binder solution.

14. The method of claim 10, wherein the preparing the buffer layer slurry further comprises:
providing LDC, toluene, ethanol, a dispersant and a binder solution so as to comprise 100 parts by weight of LDC, 75 to 85 parts by weight of toluene, 15 to 25 parts by weight of ethanol, 0.5 to 1.5 parts by weight of the dispersant, and 45 to 55 parts by weight of the binder solution, and mixing zircon balls, LDC, toluene, ethanol and the dispersant in a container, thus obtaining a mixed solution; and
mixing the mixed solution with the binder solution.

15. The method of claim 10, wherein the preparing the electrolyte layer slurry further comprises:
providing the LSGM powder, toluene, ethanol, a dispersant and a binder solution so as to comprise 100 parts by weight of the LSGM powder, 75 to 85 parts by weight of toluene, 15 to 25 parts by weight of ethanol, 0.5 to 1.5 parts by weight of the dispersant, and 45 to 55 parts by weight of the binder solution and mixing zircon balls, the LSGM powder, toluene, ethanol and the dispersant in a container, thus obtaining a mixed solution; and
mixing the mixed solution with the binder solution.

16. The method of claim 10, wherein the cathode slurry comprises 100 parts by weight of LSCF, 95 to 105 parts by weight of LSGM, 76 to 90 parts by weight of terpineol, and 3 to 15 parts by weight of ethylene cellulose.

17. A solid oxide fuel cell, comprising:
an anode diffusion layer comprising NiO, GDC (Gadolinia-Doped Ceria) and a carbon material;
an anode reaction layer formed on the anode diffusion layer and comprising NiO, GDC and the carbon material;
a buffer layer formed on the anode reaction layer and comprising LDC (Lanthanum-Doped Ceria);
an electrolyte layer formed on the buffer layer and comprising an LSGM powder obtained by the method of claim 1; and
a cathode formed on the electrolyte layer and comprising LSCF (Lanthanum-Strontium-Cobalt-Ferrite Oxide) and the LSGM powder.
